(19) United States
(12) Patent Application Publication
(10) Pub. No.: US 2023/0067105 A1
(43) Pub. Date: Mar. 2, 2023

(54) METHOD AND APPARATUS FOR SECURE DISPLAY OF ELECTRONIC INFORMATION

(71) Applicant: Tritium Holdings Pty Ltd, Brisbane (AU)

(72) Inventors: Jeremy Vincent Street-Thomas, Brisban (AU); Alexander Kris Rudzki, Brisbane (AU); Jakub Tkaczyk, Brisbane (AU); Luke James Hovington, Brisbane (AU); James McFarlane Kennedy, Brisbane (AU)

(21) Appl. No.: 17/797,009

(22) PCT Filed: Feb. 3, 2021
(86) PCT No.: PCT/AU2021/050081

§ 371 Date: Aug. 2, 2022

(30) Foreign Application Priority Data
Feb. 3, 2020 (AU) 2020900289

(51) Int. Cl. G09G 3/36

(52) U.S. Cl. CPC G09G 3/36; G09G 2358/00; G09G 2360/18; G09G 2380/10

(57) ABSTRACT

A trusted screen overlay (TSO) assembly comprising:
an electronic display;
a source of unsecure pixel data for display on the electronic display;
a source of secure pixel data for displaying on an overlay region of the electronic display;
a switching arrangement including a switch control assembly and a switch, the switch arranged to switch the electronic display between the source of unsecure pixel data and the source of secure pixel data under control of the switch control assembly; and
the switch control assembly being responsive to the source of unsecure pixel data and configured to operate the switch to switch the electronic display to the source of secure pixel data by tracking locations of pixels in unsecure pixel data from the source of unsecure pixel data, relative to the overlay region of the electronic display.

### TECHNICAL FIELD

The present invention relates to an apparatus and a method for securely displaying electronic information.

### BACKGROUND

Any references to methods, apparatus or documents of the prior art are not to be taken as constituting any evidence or admission that they formed, or form part of the common general knowledge.

There are a number of situations where it is necessary to be able to display electronic information in a secure fashion in conjunction with general information which may not necessarily have the same high level of security requirements. It is desirable that a viewer of information that has an associated high level of security can be confident that the displayed information is authentic and has not been interfered with by an agent with mal-intent.

For example, at present electric vehicle recharging stations are not subject to the same rigorous requirements as petrol pumps. Consequently, the consumer will often be unsure of just how much electricity has been delivered or of the relationship between the cost for the charge and the amount of electricity delivered.

Recently there have been moves afoot in California and in Germany to require providers of recharging stations to ensure that consumers are provided with information including the amount of electricity (e.g., in kWh), the duration of the delivery and the cost for the supply of the electricity.

In Germany, the relevant regulatory proposal is set out in Anwendungsregel VDE-AR-E 2418-3-100, which requires that legally relevant data be displayed in a secure manner that meets certification standards.

For example, petrol pumps are regularly certified to ensure that they actually dispense the volume of petrol indicated to the consumer. While electric vehicle charge station DC meters are usually certified by a regulating authority in the country in which the charging system is installed, approaching legislation will require that legally mandated information can be displayed to a user in a secure and certifiable fashion.

In other situations too there is a need to be able to overlay secure information on a display alongside information that may be from a source which is less than secure.

It is an object of the present invention to address the above need.

### SUMMARY OF THE INVENTION

In one aspect of the present invention there is provided a trusted screen overlay (TSO) assembly comprising:

at least one switching arrangement having a first input responsive to a first source of data and at least one second input coupled to one of one or more second sources of data and including a switch for switching therebetween; and an electronic display responsive to the at least one switching arrangement.

In an embodiment the first source of data comprises unsecure data. The unsecure data is preferably in the form of unsecure pixel data.

In an embodiment the at least one second input comprises secure data. The secure data is preferably in the form of secure pixel data for display on an overlay region of the electronic display.

In an embodiment the at least one switching arrangement includes a switch control assembly responsive to the unsecure source of pixel data for operating the switch to thereby switch to the second source of data upon the first source of data and the second source of data becoming synchronized.

In an embodiment the switch control assembly is responsive to the source of unsecure pixel data and is configured to operate the switch to switch the electronic display to the source of secure pixel data by tracking locations of pixels in the unsecure pixel data relative to the overlay region of the electronic display.

In a preferred embodiment the screen overlay assembly includes a timing extraction sub-assembly for extracting synchronization data from the unsecure data signal.

In an embodiment the switch comprises a multiplexer.

In an embodiment the screen overlay assembly includes a communication sub-assembly arranged for secure communication with the second source of data via the second input.

In an embodiment the second source of data comprises an electricity meter controller responsive to electricity consumption sensors and arranged to produce electricity consumption data for inclusion in the display of secure data.

In an embodiment first source of data comprises a human-machine-interface (HMI) controller for producing the unsecure data.

Preferably the HMI controller forms part of the screen overlay assembly.

In an embodiment the screen overlay assembly includes a frame generation sub-assembly for generating display frames of secure pixel data.

In an aspect of the present invention there is provided a method for overlaying a display of unsecure information on an electronic display screen with a screen portion of secure information, the method comprising:
monitoring a signal path containing the unsecure information;
monitoring a signal path containing the secure information;
switching an input to the electronic display from the signal path containing the unsecure information to the signal path containing the secure information to thereby display the secure information on the screen portion of secure information.

In a preferred embodiment the method includes writing the secure information to a frame buffer.

Preferably the method includes switching the input to the electronic display from the signal path containing the unsecure information to a signal path corresponding to the frame buffer.

In a preferred embodiment the method includes switching the input to the electronic display upon synchronization between signals on the signal path and the frame buffer becoming available.

In an aspect of the present invention there is provided a trusted screen overlay (TSO) assembly comprising:
an electronic display;
a source of unsecure pixel data for display on the electronic display;
a source of secure pixel data for displaying on an overlay region of the electronic display;
a switching arrangement including a switch control assembly and a switch, the switch arranged to switch the electronic display between the source of unsecure pixel data and the source of secure pixel data under control of the switch control assembly; and
the switch control assembly being responsive to the source of unsecure pixel data and configured to operate the switch to switch the electronic display to the source of secure pixel data by tracking locations of pixels in unsecure pixel data from the source of unsecure pixel data, relative to the overlay region of the electronic display.

In an embodiment the TSO assembly includes a communications module arranged to decrypt secure data from an external secure data source, wherein the source of secure pixel data is coupled to the communications module.

In an embodiment the source of secure pixel data comprises a secure pixel frame generation sub-assembly arranged to generate frames of secure pixel data for display on the overlay region of the electronic display.

In an embodiment the secure pixel frame generation sub-assembly includes a central processing unit configured to render output from the communications module to thereby generate the secure pixel data.

In an embodiment the secure pixel frame generation sub-assembly includes a secure pixel data frame buffer arrangement for storing frames of the secure pixel data.

In an embodiment the secure pixel data frame buffer arrangement includes a shadow frame buffer and a master frame buffer.

In an embodiment the secure pixel frame generation sub-assembly is configured to write secure pixel data to the shadow frame buffer for preventing data corruption of the secure pixel data prior to loading shadow frame buffer content to the master frame buffer.

In an embodiment an output of the switch control assembly is coupled to the secure pixel data frame buffer arrangement to apply an override signal thereto.

In an embodiment an output of the switch control assembly is coupled to the switch to apply the override signal thereto.

In an embodiment a first input of the switch is coupled to the source of secure pixel data.

In an embodiment the first input to the switch is coupled to the secure pixel data frame buffer arrangement.

In an embodiment the switching arrangement includes a decoder wherein the switch control arrangement is coupled to the source of unsecure pixel data via the decoder.

In an embodiment the first input to the switch is coupled to the secure pixel data frame buffer arrangement via a video encoder wherein the video encoder receives output from the decoder to thereby synchronize secure pixel data from the data frame buffer arrangement with the unsecure pixel data.

In an embodiment the source of unsecure pixel data is configured to generate the unsecure pixel data as a Low Voltage Differential Signaling (LVDS) signal.

In an embodiment the decoder comprises an input LVDS serializer/de-serializer module.

In an embodiment the video encoder comprises an output LVDS serializer/de-serializer module

In an embodiment the switch comprises a LVDS mux.

In an embodiment the switching arrangement stores data defining a frame region to be overridden corresponding to the overlay region of the electronic display.

In an embodiment the switch control assembly includes start and end pixel registers that store index values defining the frame region to be overridden corresponding to the overlay region of the electronic display.

In an embodiment the switching arrangement includes a pixel counter sub-assembly arranged to track a present pixel location of a frame of the unsecure pixel data with reference to the index values.

In an embodiment the source of unsecure pixel data comprises a human-machine-interface (HMI) controller.

In an embodiment the TSO assembly includes the external secure data source wherein the external secure data source comprises an electricity meter controller responsive to electricity consumption sensors and arranged to produce electricity consumption data for display as the secure pixel on the overlay region.

In an aspect there is provided a daisychain of the TSO assemblies, wherein each TSO assembly of the daisychain includes a respective source of secure pixel data corresponding to an external source of secure data and wherein a first one of the TSO assemblies is coupled to the source of unsecure pixel data and the electronic display is coupled to the switching arrangement of a last one of the TSO assemblies.

In an aspect there is provided a trusted screen overlay (TSO) assembly comprising:
an electronic display;
a source of unsecure pixel data for display on the electronic display;
i=1 to n sources of secure pixel data for display on respective i=1 to n overlay regions of the electronic display;
i=1 to n switching arrangements corresponding to the i=1 to n sources of secure pixel data, each of the i=1 to n switching arrangements including:
   a switch control assembly and a switch coupled thereto, the switch arranged to switch an output of the switch between the source of unsecure pixel data and the ith source of secure pixel data;
   the switch control assembly being responsive to the source of unsecure pixel data and configured to operate the switch to switch the output of the switch to receive the ith source of secure pixel data by tracking locations of pixels in the unsecure pixel data with reference to the ith overlay region of the electronic display;
   wherein the electronic display is responsive to the output of the nth switch. In the above, “n” and “i” are positive integer numbers.

In an embodiment n=2. In an embodiment n=3. It will be realized that n may be greater than three depending on the size of the electronic display and the size of the overlay portions that need to be accommodated on the electronic display for each of the sources of secured pixel data.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a trusted screen overlay assembly according to an embodiment of the invention.

FIG. 2 depicts an electronic display displaying a typical screen portion of secure data overlaid on the unsecure data display.

FIG. 3 is a block diagram of a trusted screen overlay assembly according to a further embodiment of the invention for displaying secure information from multiple secure data sources in the form of multiple DC charging meter controllers.

FIG. 4 is an image of a display screen of the trusted screen overlay assembly of FIG. 3 displaying a plurality of trusted screen overlay portions.

### DETAILED DESCRIPTION OF PREFERRED EMBODIMENTS

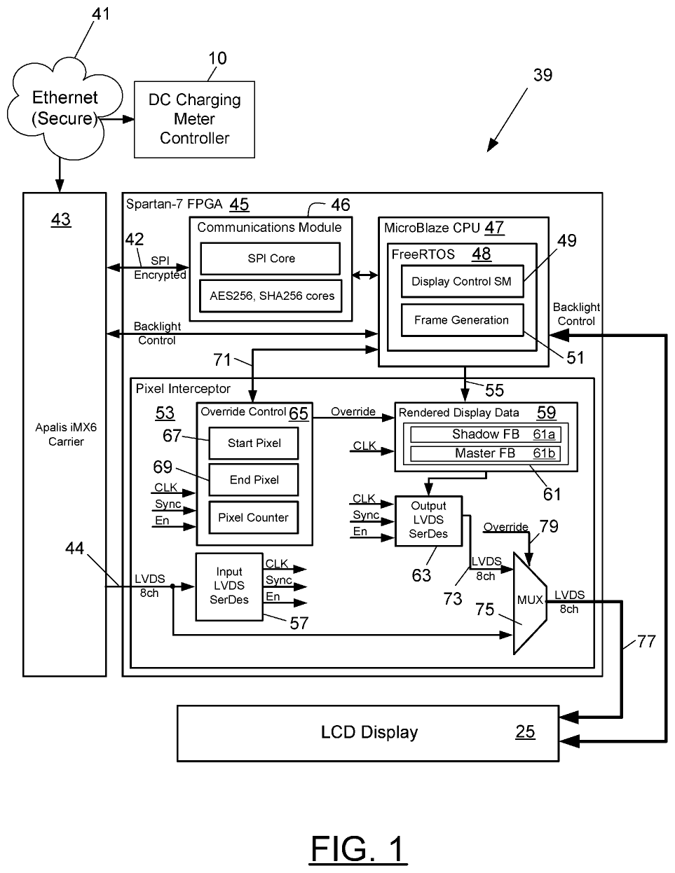

FIG. 1 is a block diagram of trusted screen overlay (TSO) assembly 39 according to an embodiment of the present invention.

The TSO assembly 39 includes a human-machine-interface (HMI) controller 43 in the form of an Apalis iMX6 carrier, which is a small form-factor computer that communicates via encrypted SPI path 42 and LVDS path 44 with specially configured FPGA 45. The HMI controller 43 provides all the required components for bi-directional, secure communications between an external source of secure data 10 and the FPGA 45 which is configured to implement a communications module 46 with SPI core and encryption/decryption cores. This secure communication is bridged between the FPGA 45 and source of secure data 10 via SPI path 42 on the HMI controller 43 and via a data network such as Ethernet network 41.

Given the communications are cryptographically signed and bi-directional, both the FPGA 45 and the source of secure data 10 can securely monitor each other's state, allowing the use of an otherwise unsecure network.

In order to minimise the complexity of the architecture of the TSO a soft core MicroBlaze CPU 47 is utilised in FPGA 45 to perform all the functionality, which is optimally completed in firmware. The soft core CPU 47 is configured with display control firmware 49 and frame generation firmware 51.

The firmware 49, 51 configures the soft core CPU 47 to perform core control system tasks including:
Managing cryptographically signed communications with the secure data source 10 via network 41, 42, 43.
Managing what data is presently displayed on LCD display 25.
Generating the pixel data, i.e. secure pixel data, to display on LCD display 25.
Monitoring the state of the display signal from the HMI controller 43.
Managing the display brightness of the LCD screen 25 to check that the backlight control of the LCD screen 25 is at a level to further ensure displayed data is legible

Pixel Interceptor 53

The pixel interceptor 53 is the main block of custom logic in the FPGA 45. Its sole purpose is intercepting unsecure low-voltage differential signal (LVDS) display data sent by the HMI computer 43 to the LCD display 25 via LVDS signal path 44. Where the display is used in a vehicle charging station, the unsecure data may include information such as advertisements, help guides, charging status and charging authentication user prompts

The specific pixels required to display legally relevant data are overridden by the interceptor 53 before being sent through to the LCD display 25. This method of display overlay ensures that the secure data, which originates in secure data source 10 and which proceeds along signal path 55 from the soft core CPU 47 as secure pixel data, is always readable and not modified by any third-party software on the HMI controller 43.

The pixel interceptor 53 is comprised of several functional blocks which are discussed below.

Input LVDS SerDes 57

The LVDS data that proceeds along LVDS path 44 from the HMI controller 43 is decoded by the Input LVDS SerDes 57 primarily to extract display control flags and original pixel clock required to generate the overriding pixels. The decoded raw pixel data, which is unsecured pixel data, is not processed by the pixel interceptor 53 other than being switched in and out by LVDS multiplexer 75.

Rendered Display Data 59

The secure pixel data pixels from the soft core CPU 47, are received via path 55 and stored in the frame buffer 61 ready to be loaded out and sent to the LCD display 25. Frame buffer 61 includes a shadow frame buffer 61a and a master frame buffer 61b. The soft core CPU 47 specifically writes to the shadow frame buffer to prevent any data corruption.

The shadow frame buffer 61a is only loaded into the master frame buffer 61b when the following conditions are met:
A complete frame generated by the CPU 47 is ready in the shadow frame buffer 61a
The master frame buffer 61b is not presently being accessed by the Output LVDS SerDes 63.

Override Control 65

The override control 65 monitors the signals from the input LVDS SerDes 57 to track the present pixel location in the frame being sent to the display 25 from the HMI controller 43. The pixel location is required to locate the frame region that is to be overridden with the rendered secure pixel data for display. Start and end pixel registers 67, 69 receive index values provided by the soft core CPU 47 via path 71 in order to define the frame region to be overridden.

Override control 65 provides a status signal back to the soft core CPU 47, along path 71, to notify if the HMI controller 43 is sending valid frames to the LCD display 25 via unsecure data LVDS path 44. The valid frame status is required so the TSO can decide to completely override the display (including display control flags) The FPGA 45 sends this status to the meter controller 10 via encrypted SPI path 42 and thence Ethernet 41.

Output LVDS SerDes 63

Output LVDS SerDes block 63 encodes to LVDS, which is output on LVDS signal path 73, the raw pixel data (24 bit RGB) of the rendered display from the soft core CPU 47. All the signals from the input LVDS SerDes 57 are required to synchronise the pixel data with the HMI computer LVDS data on path 44. The LVDS data on signal path 73 is then ready to be directly inserted into the signal stream being sent to the display on signal path 77.

In another embodiment the MUX 75 may be before the output LVDS SerDes 63 so that the output SerDes 63 takes MUX 75 output of either unsecure or secure raw pixel data.

LVDS Multiplexer 75

The multiplexer 75 switches the source of the LVDS signal that is sent to the display via path 77 between the LVDS data on path 44 from HMI controller 43 and the pixel data originating from soft core CPU 47 along path 73. This switching is controlled by the override control block 65 via Override signal path 79.

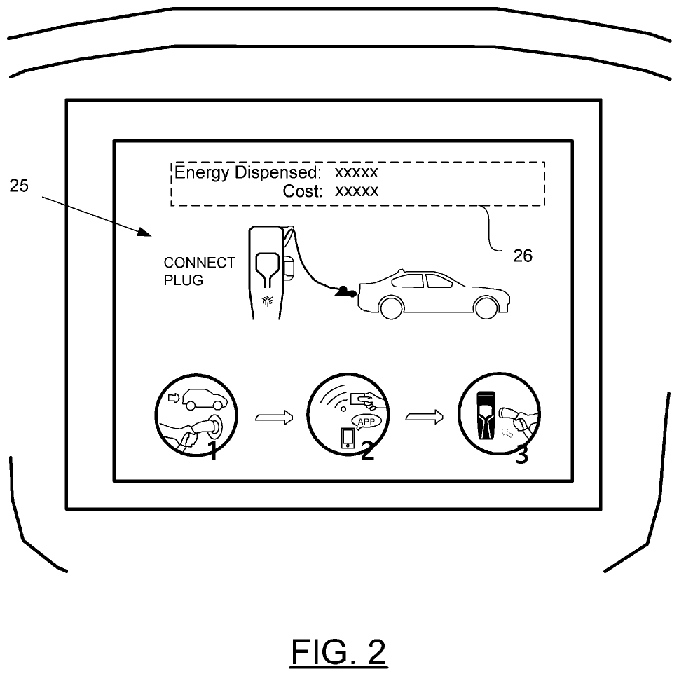

FIG. 2 shows the LCD display 25 with the multiplexer 75 switched to input path 73 so that an overridden portion 26 of the screen is produced which contains secure information and which is overlaid on the remaining, unsecured display. The display data is only overwritten in the legally relevant area 26, otherwise the unsecure data is passed through. The data stream sends each pixel to display on the screen 25, one after another. The MUX 75 only switches the specific pixels that have been specified, in real time so that no buffering is required.

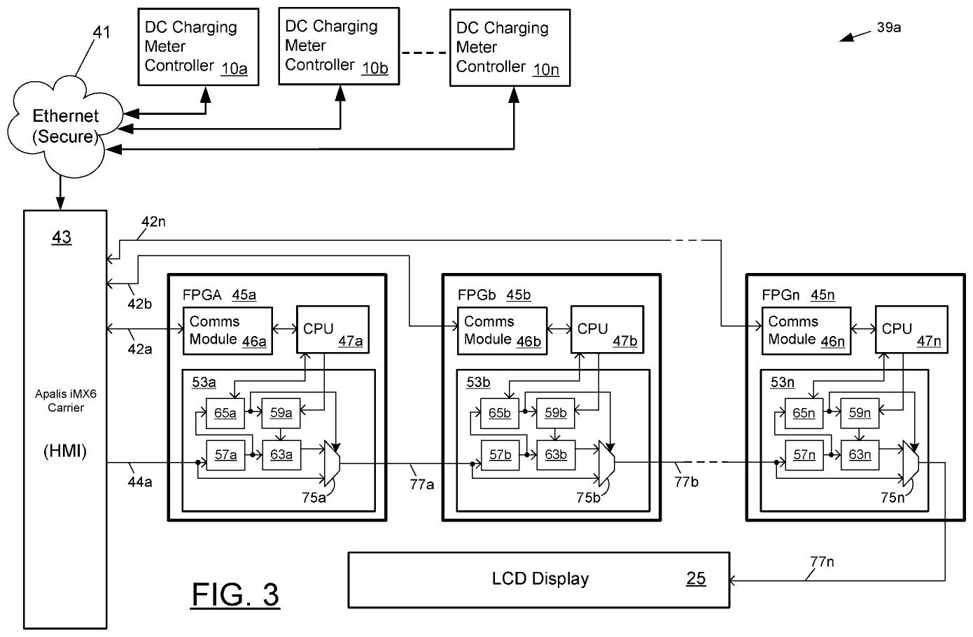

FIG. 3 is a block diagram of trusted screen overlay TSO assembly 39a according to an embodiment of the present invention. In this embodiment there are multiple sources of secure data in the form of a number of DC Charging Meter Controllers 10a, . . . ,10n which are in data communication with HMI controller 43 via Ethernet network 41. The HMI controller 43 communicates with multiple FPGA's 45a, . . . ,45n via SPI encrypted data paths 42a, . . . ,42n respectively. The HMI controller 43 also makes unsecured communication with the first FPGA 45a via LVDS path 44a. This LVDS communication is daisychained in series to other FPGA's 45b, 45n via LVDS data paths 77a, 77b, . . . ,77n-1

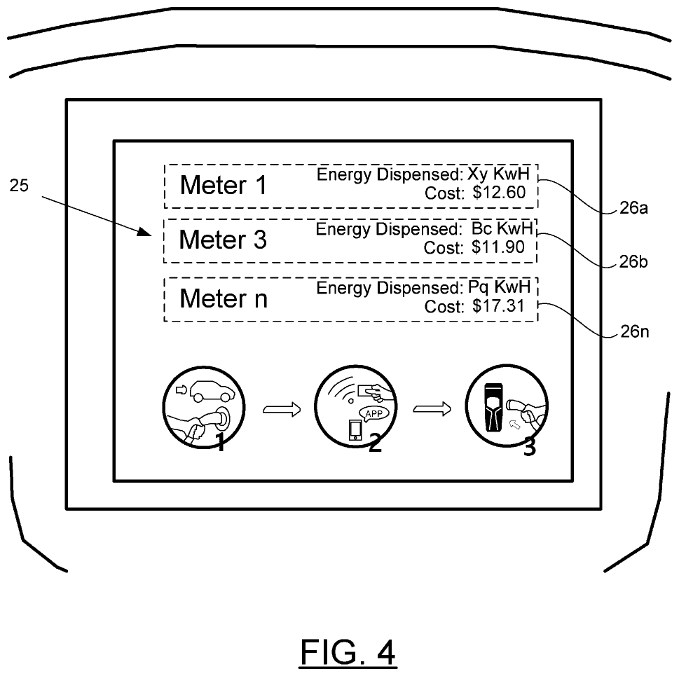

The start pixel and end pixel registers of each of the override control modules 65a, . . . ,65n receive respective index values provided by the respective soft core CPU 47a, . . . ,47n to define respective frame regions, shown in FIG. 4 as separate screen portions or “overlay regions” 26a, . . . ,26n, to be overridden.

Consequently, as illustrated in FIG. 4, a single display 25 is able to display both unsecured data, e.g. the refuelling information 24 shown in FIG. 4, alongside secured data, in screen portions 26a, . . . ,26n, for each of the secure data sources in the form of the DC Charging Meter Controllers 10a, . . . ,10n.

From the foregoing it will be understood that, as illustrated in FIG. 1, in a preferred embodiment there is provided a trusted screen overlay (TSO) assembly 39 which comprises an electronic display 25. The TSO assembly 39 includes a source of unsecure pixel data for display on the electronic display in the form of signal path input 44, which in the preferred embodiment conveys unsecure pixel data in LVDS format, though other formats may also be used in other embodiments, from the HMI controller 43. The TSO assembly 39 also includes a source of secure pixel data for displaying on an overlay region of the electronic display.

In the presently described embodiment the source of secure pixel data comprises a secure pixel frame generation sub-assembly which includes a central processing unit 47 configured by frame generation firmware 51 to render decrypted output from communications module 46 to and to generate frames of secure pixel data for displaying on the overlay region of the electronic display.

The communications module 46 is configured to decrypt secure data from an external secure data source, e.g. DC charging meter controller 10.

Accordingly, the CPU 47 generates secure pixel data which is conveyed on signal path 55.

The secure pixel frame generation sub-assembly also includes a secure pixel data frame buffer arrangement in the form of Rendered Display Data arrangement 59 for storing frames of the secure pixel data from the CPU 47.

The secure pixel data frame buffer arrangement includes a shadow frame buffer 61a and a master frame buffer 61b.

The TSO assembly 39 includes a switching arrangement which includes a switch control assembly in the form of the Override Control 65 and also includes a switch in the form of MUX 75. The switch is arranged to switch the electronic display 25 between the source of secure pixel data, 47, 59 and the source of secure pixel data 44 under control of the switch control assembly 65.

The switch control assembly, in the form of Override Control 65, is responsive to the source of unsecure pixel data comprising LVDS path 44, and ultimately HMI Interface controller 43, and is configured to operate the switch 75 to switch the electronic display 25 to the source of secure pixel data, which in the present embodiment is in the form of Rendered Data Display assembly 59, via a video encoder in the form of Output LVDS Serializer/Deserializer 63.

The Override Control 65 is configured to determine when to operate the switch 75 to override to secure pixel data by tracking locations of pixels in unsecure pixel data from the source of unsecure pixel data, relative to the overlay region 26 of the electronic display 25.

The secure pixel data frame buffer arrangement in the form of the rendered display data assembly 59 is configured to write the secure pixel data to the shadow frame buffer 61a, for preventing data corruption of the secure pixel data, prior to loading shadow frame buffer content to the master frame buffer 61b.

In addition to switch control assembly 65 being coupled to the switch 75 to apply the override signal it is also coupled to the source of secure pixel data, namely the secure pixel data frame buffer arrangement in the form of Rendered Display Data arrangement 59.

A first input to the switch (which receives “LVDS 8ch” in FIG. 1) is coupled to the secure pixel data frame buffer arrangement in the form of rendered display data assembly 59.

The switching arrangement also includes a decoder, in the form of Input LVDS SerDes module 57. The switch control assembly, in the form of Override Control 65, is coupled to the source of unsecure pixel data, HMI Interface 43, via the decoder 57 and signal path 44.

As previously mentioned, the first input to the switch 75 is coupled to the secure pixel data frame buffer arrangement 59 via a video encoder in the form of Output LVDS SerDes module 63. The video encoder 63 is responsive to the decoder 57 so that it is operational to synchronize the secure pixel data from the secure pixel data frame buffer arrangement 59 with the unsecure pixel data that is incoming along unsecure pixel source path 44.

In the presently described embodiment the source of unsecure pixel data, in the form of the HMI Interface controller 43, is configured to generate the unsecure pixel data that flows along path 44 as a Low Voltage Differential Signaling (LVDS) signal.

The decoder 57 in the present example comprises an input LVDS serializer/de-serializer module.

Similarly, in the present example the video encoder 63 comprises an output LVDS serializer/de-serializer module and as previously mentioned, the switch 75 comprises a LVDS mux.

The switching arrangement, in the form of Override Control 65, stores data defining a frame region to be overridden corresponding to the overlay region of the electronic display. In the present example the switch control assembly 65 includes start and end pixel registers, 67, 69 that store index values defining the frame region to be overridden that corresponds to the overlay region 26 of the electronic display.

The switching arrangement 65 also includes a pixel counter sub-assembly that tracks a present pixel location of a frame of the unsecure pixel data, based on the output of decoder 57, with reference to the index values stored in the start and end pixel registers 67,69.

The source of unsecure pixel data in the present example comprises the human-machine-interface (HMI) controller 43 which is implemented by a suitably programmed small format computer.

The TSO assembly can be provided with the external secure data source. For example, the external secure data source may comprise electricity meter controller 10, which is responsive to electricity consumption sensors and arranged to produce electricity consumption data for displaying as the secure pixel data on the overlay region. Such controllers and sensors are known in the context of electric vehicle charging stations for example.

The daisychain of TSO assemblies illustrated in FIG. 3 may be referred to as a “multiple trusted secure data overlay assembly”. It comprises an electronic display 25 including a number of overlay regions 26a, . . . ,26n (FIG. 4) each for displaying secure pixel data from a respective source of secure data such as DC charging meter controllers 10a, . . . ,10n

The multiple trusted secure data overlay assembly also includes a daisychain of TSO assemblies in the form of FPGA's 45a, . . . ,45n. The output 77n of the daisychain is coupled to the electronic display, each of the TSO assemblies of the daisychain, e.g. FPGA's 45a, . . . ,45n corresponds to the FPGA 45 of FIG. 1. Each TSO assembly 45a, 45b, 45n of the daisychain includes a respective source of secure pixel data corresponding to an external source 10a, 10b, 10n of secure data. A first one 45a of the TSO assemblies is coupled to the source of unsecure pixel data and the electronic display 25 is coupled to the switching arrangement of a last one of the TSO assemblies.

Accordingly, the assembly that is illustrated in FIG. 3 assembly includes 1=1 to n TSO sub-assemblies 45a, 45b, . . . ,45n. Sub-assembly 45a is the 1st sub-assembly (i.e. 1=1), sub-assembly 45b, is the 2^{nd} (i.e. 1=2) and sub-assembly 45n is the n^{th} sub-assembly (i.e. i=n) where n is a positive integer greater than 1. The sub-assemblies 45a-45n are serially coupled to electronic display 25 via switches 75a, . . . ,75n. A source of unsecure pixel data such as HMI Interface 43 is also provided and is coupled to an input of the first TSO sub-assembly 45a via path 44a. The HMI Interface 43 generates the unsecure pixel data for display on the electronic display 25, e.g., as display portion 24 in FIG. 4. There are i=1 to n sources of secure pixel data for display on respective i overlay regions (e.g. regions 26a, . . . ,26n of FIG. 4) of the electronic display 25. Each of the sources of secure pixel data is as previously described with reference to FIG. 1, that is, each of the sources of secure pixel data comprises a secure pixel frame generation sub-assembly which includes a central processing unit 47 configured by frame generation firmware 51 to render decrypted output from communications module 46 to and to generate frames of secure pixel data for displaying on the overlay region of the electronic display. There are also provided i=1 to n switching arrangements corresponding to the i sources of secure pixel data.

Each of the i switching arrangements includes a switch control assembly, such as Override Control 65, and a switch coupled thereto, such as MUX 75, the switch 75 is arranged to switch an output of the switch between the source of unsecure pixel data 43, for example HMI Interface controller 43, and the ith source of secure pixel data. The switch control assembly 65 is responsive to the source of unsecure pixel data 43 and is configured to operate the switch 75 to switch the output to the ith source of secure pixel data, e.g. CPUs 47a, . . . ,47n and Rendered Display Data assemblies 59, by tracking locations of pixels in the unsecure pixel data with reference to the ith overlay region (e.g. one of regions 26a, . . . ,26n) of the electronic display 25 as shown in FIG. 4. The electronic display 25 is responsive to the output of the n^{th} switch, i.e. switch 75n of FIG. 3.

It will be realised that even in the event of an agent of mal-intent attempting to masquerade a portion of the unsecure pixel data that makes up display 24, as secure information, the switch control assembly, in the form of Override Control 65 will continue to operate switches 75a, . . . ,75n to fill the overlay portions 26a, . . . ,26n of the display with legitimate secure pixel data so that the masquerade will be immediately apparent.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. For example, whilst the embodiments described herein have used a Field Programmable Gate Array (FPGA) configured to implement the CPU 47, the CPU might be implemented as a discrete hardware microprocessor with other sub-assemblies that are implemented by the FPGA being implemented using circuits of discrete logic gates. In other embodiments there may also be more than one source of unsecured data.

The invention is, therefore, claimed in any of its forms or modifications within the proper scope of the appended claims appropriately interpreted by those skilled in the art.

The present specification discloses not only the various embodiments that have been discussed in the Summary and which are the subject of the claims as originally filed at the end of this specification, but also further combinations of the features set forth in the Summary, Detailed Description, Figures and Claim portions of the present specification. For example, the application as originally filed includes twenty-seven claims including claim 1, being an independent claim and claims 2 to 23 each being ultimately dependent on claim 1. It is clearly and unambiguously brought to the reader's attention that further embodiments of the Invention encompass claim 1 in combination with one or more features of each of claims 2 to 23. Similarly, further embodiments of the invention may comprise the features of each of independent claim 24 or 26 or 27, as originally filed, in combination with one or more features of each of the dependent claims and/or with one or more features set forth in the body of the specification as filed whether in the Summary or Detailed Description or Figures. As an example, based on claim 1, during examination or subsequent to grant, the Applicant may amend claim 1 to include the feature(s) of claim 1 and/or claim 2 and/or claim 3 etc. up to and/or claim 23 and/or one or more features from the detailed description, depending on prior art cited during examination. It will be realized that it is not possible for any Applicant to have knowledge of all possibly relevant prior art that exists and thus amendment may be necessary to distinguish an embodiment of the present invention from prior art that is cited during examination or post-grant. In order to provide a non-limiting example, embodiments of the present invention include claim 1 in combination with the feature of claim 20; claim 1 in combination with the feature of claim 19; claim 1 in combination with the feature of claim 14 and similarly encompasses all other combinations of features as set forth in the claims as filed and also in the Detailed Description, Summary and Figures. An amendment to the claims as has been described above will therefore result in a claimed invention that is disclosed by the present specification as originally filed since it has been clearly and unambiguously explained that the invention encompasses such combinations of features.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the scope of the invention.

1. A trusted screen overlay (TSO) assembly comprising:
an electronic display;
a source of unsecure pixel data for display on the electronic display;
a source of secure pixel data for displaying on an overlay region of the electronic display;
a switching arrangement including a switch control assembly and a switch, the switch arranged to switch the electronic display between the source of unsecure pixel data and the source of secure pixel data under control of the switch control assembly; and
the switch control assembly being responsive to the source of unsecure pixel data and configured to operate the switch to switch the electronic display to the source of secure pixel data by tracking locations of pixels in unsecure pixel data from the source of unsecure pixel data, relative to the overlay region of the electronic display.

2. The TSO assembly of claim 1, including a communications module arranged to decrypt secure data from an external secure data source, wherein the source of secure pixel data is coupled to the communications module.

3. The TSO assembly of claim 2, wherein the source of secure pixel data comprises a secure pixel frame generation sub-assembly arranged to generate frames of secure pixel data for displaying on the overlay region of the electronic display.

4. The TSO assembly of claim 3, wherein the secure pixel frame generation sub-assembly includes a central processing unit configured to render output from the communications module to thereby generate secure pixel data.

5. The TSO assembly of claim 4, wherein the secure pixel frame generation sub-assembly includes a secure pixel data frame buffer arrangement for storing frames of the secure pixel data.

6. The TSO assembly of claim 5, wherein the secure pixel data frame buffer arrangement includes a shadow frame buffer and a master frame buffer.

7. The TSO assembly of claim 6, wherein the secure pixel frame generation sub-assembly is configured to write the secure pixel data to the shadow frame buffer for preventing data corruption of the secure pixel data prior to loading shadow frame buffer content to the master frame buffer.

8. The TSO assembly of claim 5, wherein an output of the switch control assembly is coupled to the secure pixel data frame buffer arrangement to apply an override signal thereto.

9. The TSO assembly of claim 5, wherein the switch control assembly is coupled to the switch to apply the override signal thereto.

10. The TSO assembly of claim 5, wherein a first input of the switch is coupled to the source of unsecure pixel data.

11. The TSO assembly of claim 10, wherein the first input to the switch is coupled to the secure pixel data frame buffer arrangement.

12. The TSO assembly of claim 11, wherein the switching arrangement includes a decoder wherein the switch control assembly is coupled to the source of unsecure pixel data via the decoder.

13. The TSO assembly of claim 12, wherein the first input to the switch is coupled to the secure pixel data frame buffer arrangement via a video encoder wherein the video encoder is responsive to the decoder to thereby synchronize the secure pixel data from the secure pixel data frame buffer arrangement with the unsecure pixel data.

14. The TSO assembly of claim 12, wherein the source of unsecure pixel data is configured to generate the unsecure pixel data as a Low Voltage Differential Signaling (LVDS) signal.

15. The TSO assembly of claim 14, wherein the decoder comprises an input LVDS serializer/de-serializer module and wherein the video encoder comprises an output LVDS serializer/de-serializer module.

16. (canceled)

17. The TSO assembly of claim 14, wherein the switch comprises a LVDS mux.

18. The TSO assembly of claim 1, wherein the switching arrangement stores data defining a frame region to be overridden corresponding to the overlay region of the electronic display.

19-22. (canceled)

23. A daisychain of TSO assemblies, each TSO assembly of the daisychain of TSO assemblies according to claim 1, wherein each TSO assembly of the daisychain includes a respective source of secure pixel data corresponding to an external source of secure data and wherein a first one of the TSO assemblies is coupled to the source of unsecure pixel data and the electronic display is coupled to the switching arrangement of a last one of the TSO assemblies.

24. A trusted screen overlay (TSO) assembly comprising:
an electronic display;
a source of unsecure pixel data for display on the electronic display;
i=1 to n sources of secure pixel data for display on respective i=1 to n overlay regions of the electronic display;
i=1 to n switching arrangements corresponding to the i=1 to n sources of secure pixel data, each of the i=1 to n switching arrangements including:
a switch control assembly and a switch coupled thereto, the switch arranged to switch an output of the switch between the source of unsecure pixel data and the ith source of secure pixel data;
the switch control assembly being responsive to the source of unsecure pixel data and configured to operate the switch to switch the output of the switch to receive the ith source of secure pixel data by tracking locations of pixels in the unsecure pixel data with reference to the ith overlay region of the electronic display; and
wherein the electronic display is responsive to the output of the nth switch.

25. The TSO assembly of claim 24 wherein n is equal to, or greater than, 2.

26-27. (canceled)
